(19) United States
(12) Patent Application Publication
(10) Pub. No.: US 2024/0258694 A1
(43) Pub. Date: Aug. 1, 2024

(54) DUAL BAND PRINTED F-ANTENNA USING A TRAP WITH SMALL BAND SEPARATION

(71) Applicant: Honeywell International Inc., Charlotte, NC (US)

(72) Inventors: Zhong Liu, Doylestown, PA (US); Justin Jose, Muvattupuzha (IN); Amit Kulkarni, Duluth, GA (US)

(21) Appl. No.: 18/354,434

(22) Filed: Jul. 18, 2023

Related U.S. Application Data
(60) Provisional application No. 63/481,724, filed on Jan. 26, 2023.

(51) Int. Cl. H01Q 5/321; H01Q 9/04

(52) U.S. Cl. CPC H01Q 5/321; H01Q 9/0421

(57) ABSTRACT

A dual band inverted-F antenna includes a first antenna element having a first leg connected to a ground plane and a second leg extending along a length from the first leg to a distal end of the second leg. A second antenna element connects to the second leg at a first connection point that is proximal of the distal end of the second leg, the second antenna element electrically coupled to an antenna signal trace of a PCB. A third antenna element is spaced from the second leg of the first antenna element by a gap and positioned along the length of the second leg proximal of the distal end of the second leg but distal of the first connection point. A trap is operatively coupled across the gap between the second leg of the first antenna element and the third antenna element.

### RELATED APPLICATIONS

This application claims the benefit of U.S. Provisional Patent Application Ser. No. 63/481,724, filed Jan. 26, 2023, which application is incorporated by reference herein.

### TECHNICAL FIELD

The present disclosure pertains to antennas that may be used in a variety of wireless applications and more particularly pertains to dual band antennas having a small frequency band separation.

### BACKGROUND

A variety of electronic devices utilize antennas for wirelessly transmitting and/or receiving information. In some cases, it may be desirable for an electronic device to have the capability of communicating over two or more different frequency bands. What would be desirable is a dual band antenna that can be easily and inexpensively incorporated into a variety of different electronic devices to support communication over each of two different frequency bands.

### SUMMARY

This disclosure pertains to generally antennas that may be used in a variety of wireless applications and more particularly pertains to dual band antennas having a small frequency band separation. An example may be found in a dual band inverted-F antenna. The illustrative dual band inverted-F antenna includes a ground plane formed by a first conductive layer of a Printed Circuit Board (PCB). A first antenna element is formed by the first conductive layer, the first antenna element having a first leg and a second leg, wherein the first leg is connected to the ground plane, and the second leg extends along a length from the first leg to a distal end of the second leg parallel to the ground plane. A second antenna element is formed by the first conductive layer, the second antenna element connected to the second leg of the first antenna element at a first connection point along the length of the second leg that is proximal of the distal end of the second leg, the second antenna element electrically coupled to an antenna signal trace of the PCB. A third antenna element is formed by the first conductive layer, the third antenna element is spaced from the second leg of the first antenna element by a gap and positioned along the length of the second leg proximal of the distal end of the second leg but distal of the first connection point. A trap is operatively coupled across the gap between the second leg of the first antenna element and the third antenna element.

Another example may be found in a dual band inverted-F antenna that includes a planar inverted-F antenna with a trap, and is configured to have a first frequency band and a second frequency band. The first frequency band is separated from the second frequency band by less than 100 MHz.

Another example may be found in a dual band inverted-F antenna. The dual band inverted-F antenna includes a planar inverted-F antenna with a trap, and is configured to have a first frequency band and a second frequency band. The first frequency band includes 865-870 MHz and the second frequency band includes 905-925 MHz.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic diagram showing an illustrative dual band inverted-F antenna;

FIG. 2 is a schematic diagram showing an illustrative trap used as part of the illustrative dual band inverted-F antenna of FIG. 1;

FIG. 3 is a schematic diagram showing the illustrative dual band inverted-F antenna of FIG. 1, with various dimensions annotated; and

FIG. 4 is a graphical representation of a simulated frequency response for the inverted-F antenna of FIGS. 1-3.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The term “about” means within a range of plus or minus 10 percent of the expressed number. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

A dual band inverted-F antenna is described herein. The dual band inverted-F antenna may be a printed antenna, sometimes printed on a Printed Circuit Board (PCB). In some cases, the dual band inverted-F antenna may provide a first frequency band and a second frequency band, where the second frequency band is different from the first frequency band but is relatively close to the first frequency band (e.g. within 100 MHz). In some instances, the dual band inverted-F antenna may include a trap to help create the first and second frequency bands. As an example, the trap may include one or more capacitors and one or more inductors connected in parallel, and may act as a band stop (e.g. notch) filter. In one example, for a dual band inverted-F antenna having a first frequency band between 865 MHz and 870 MHz and a second frequency band between 902 MHz and 928 MHz, a capacitor having a capacitance of 9.1 ±0.05 pF (pico farads) and one or more inductors with a total effective inductance of 3.4 nH (nano henry) with a tolerance of ±2 percent may be used.

In some instances, the dual band inverted-F antenna may be designed to utilize the first frequency band when used in electronic devices in parts of the world that utilize the first frequency band, and to utilize the second frequency band when used in electronic devices in parts of the world that utilize the second frequency band. It is contemplated that the dual band inverted-F antenna may be used in an electronic device that is configured to utilize both frequency bands.

An example of a dual band inverted-F antenna includes a ground plane formed by one or more conductive layers of a Printed Circuit Board (PCB). In some cases, conductive layer(s) and insulative layer(s) of the PCB may have a total thickness of 1.6 millimeters. The PCB insulative layer(s) may be formed of, or otherwise include, FR4. FR4 is a fiberglass-reinforced epoxy laminate material, and is considered to be flame-retardant. FR-4 glass epoxy has a good strength to weight ratio.

In one example, a first antenna element is formed by a first conductive layer. The first antenna element has a first leg and a second leg, where the first leg is connected to the ground plane, and the second leg extends parallel to the ground plane along a length from the first leg to a distal end of the second leg. A second antenna element is formed by the first conductive layer and is connected to the second leg of the first antenna element at a first connection point along the length of the second leg. The first connection point is proximal of the distal end of the second leg. The second antenna element is electrically coupled to an antenna signal trace of the PCB. The first antenna element and the second antenna element collectively form an antenna that is configured to operate in the first frequency band (e.g. 902-928 MHz). A third antenna element is formed by the first conductive layer and is spaced from the second leg of the first antenna element by a gap. The third antenna element is positioned along the length of the second leg of the first antenna element proximal of the distal end of the second leg but distal of the first connection point. The third antenna element is configured (sized and shaped) to operate in a second frequency band (e.g. 865-870 MHz). The third antenna element is electrically connected to the second leg of the first antenna element through a trap, and thus electrically connected to the second antenna element and the antenna signal trace.

To help block electrical current of the first frequency in the second leg of the first antenna element from flowing across the gap to the third antenna element, the trap is operatively coupled across the gap between the second leg of the first antenna element and the third antenna element. The trap may be coupled to the second leg at a second connection point along the length of the second leg. The second connection point is proximal of the distal end of the second leg but distal of the first connection point.

In one example, the trap may include an inductor that is coupled between the second leg of the first antenna element and the third antenna element, and a capacitor that is coupled between the second leg of the first antenna element and the third antenna element in parallel with the inductor. In some instances, the second connection point is located proximal of the distal end of the second leg by a distance of at least 10 percent of the total length of the second leg. In some instances, the first connection point is located proximal of the distal end of the second leg by a distance of at least 50 percent of the total length of the second leg. In some cases, the inductor and the capacitor may be surface mount components that are positioned across the gap and soldered direct to the first antenna element and the third antenna element.

In some instances, the antenna signal trace may be operatively coupled to a dual band radio circuitry that is mounted to the PCB. In some instances, the antenna signal trace of the PCB may be operatively coupled to filter circuitry mounted to the PCB. In some instances, the antenna signal trace of the PCB may be operatively coupled to amplifier circuitry mounted to the PCB.

In some instances, the dual band inverted-F antenna may be sensitive in a first frequency band and a second frequency band, wherein the first frequency band is non-overlapping with the second frequency band. As an example, the first frequency band may include 865-870 MHz and the second frequency band may include 902-928 MHz. In some instances, the first frequency band may have a bandwidth of at least 5 MHz with a −10 dB return loss or less within the band, and the second frequency band may have a bandwidth of at least 20 MHz with a −10 dB return loss or less within the band. In some cases, the first frequency band may be separated from the second frequency band by less than 100 MHz.

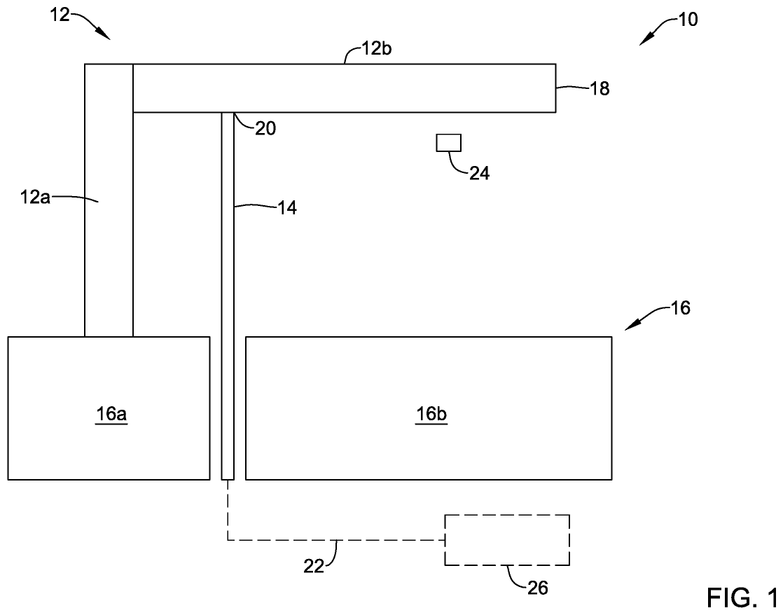

FIG. 1 is a schematic diagram showing an illustrative dual band inverted-F antenna 10. The illustrative dual band inverted-F antenna 10 includes a first antenna element 12, a second antenna element 14 and a third antenna element 24. The first antenna element 12 includes a first leg 12a and a second leg 12b. The first leg 12a is connected to a ground plane 16 that, as seen, may be considered as being divided into a first ground plane section 16a and a second ground plane section 16b. The second leg 12b extends along a length from the first leg 12a to a distal end 18 of the second leg 12b. In this example, the second leg 12b extends parallel to the ground plane 16. The second antenna element 14 is connected to the second leg 12b at a first connection point 20 along the length of the second leg 12b that is proximal (e.g. to the left of in FIG. 1) of the distal end 18 of the second leg 12b. In this example, the ground plane 16, the first antenna element 12 and the second antenna element 14 are each formed by a first conductive layer of a Printed Circuit Board (PCB), although this is not required. The second antenna element 14 is electrically coupled to an antenna trace signal 22 of the PCB. In some instances, the antenna trace signal 22 may be considered as having an impedance that matches that of the dual band inverted-F antenna 10. This may help prevent signal reflections at the interface between the antenna trace signal 22 and the dual band inverted-F antenna 10, thereby improving the effective antenna efficiency.

The third antenna element 24 is spaced from the second leg 12b of the first antenna element 12 by a gap. The third antenna element 24 is positioned along the length of the second leg 12b of the first antenna element 12 proximal of the distal end 18 of the second leg 12b but distal of the first connection point 20. The third antenna element 24 is configured (sized and shaped) to operate in the second frequency band. The third antenna element is electrically connected to the second leg 12b of the first antenna element 12 via the trap, and thus to the second antenna element 14 and the antenna trace signal 22.

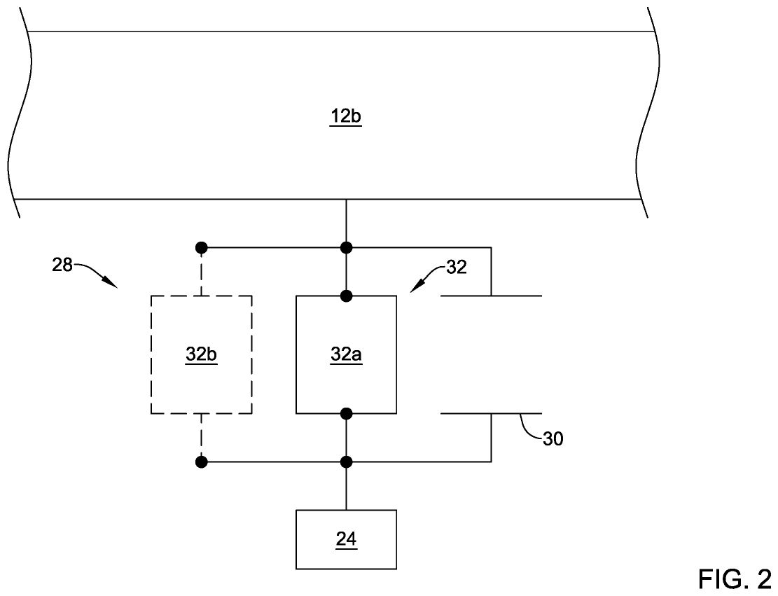

To help block electrical current of the first frequency in the second leg 12b of the first antenna element 12 from flowing to the third antenna element 24, the trap 28 (e.g. trap shown in FIG. 2) is operatively coupled across the gap between the second leg 12b of the first antenna element 12 at the third antenna element 24. The trap 28 may be coupled to the second leg 12b at a second connection point along the length of the second leg 12b. The second connection point is proximal of the distal end 18 of the second leg 12b but distal of the first connection point 20.

In one example, and as shown in FIG. 2, the trap 28 may include an inductor 32a that is coupled between the second leg 12b of the first antenna element 12 and the third antenna element 24, and a capacitor 30 that is coupled between the second leg 12b of the first antenna element 12 and the third antenna element 24 in parallel with the inductor 32a. In some instances, a capacitor opposes a change in voltage and stores energy in the form of an electric field. In some instances, an inductor opposes a change in current and stores energy in the form of a magnetic field. In some instances, the second connection point is located proximal of the distal end 18 of the second leg 12b by a distance of at least 10 percent of the total length of the second leg 12b. In some instances, the first connection point 20 is located proximal of the distal end 18 of the second leg 12b by a distance of at least 50 percent of the total length of the second leg 12b. In some cases, the inductor 32a and the capacitor 30 may be surface mount components that are positioned across the gap and soldered direct to the second leg 12b of the first antenna element 12 and the third antenna element 24.

The illustrative dual band inverted-F antenna 10 may h be operatively coupled to an electrical component 26. In some cases, the electrical component 26 may be mounted onto the same PCB that the rest of the dual band inverted-F antenna 10 is formed from. In some instances, the electrical component 26 may be a radio. In some instances, the electrical component 26 may be a dual band radio. In some instances, the electrical component 26 may 26 may include filtering circuitry (e.g. bandpass filtering). In some instances, the electrical component 26 may include amplifier circuitry. In some instances, the electrical component 26 may include impedance-matching circuitry. These are just examples.

In some instances, the dual band inverted-F antenna 10 may be sensitive in a first frequency band and a second frequency band, wherein the first frequency band is non-overlapping with the second frequency band. As an example, the first frequency band may include 865-870 MHz and the second frequency band may include 902-928 MHz. In some cases, the first frequency band may have a bandwidth of at least 5 MHz with a −10 dB return loss or less within the band, and the second frequency band may have a bandwidth of at least 20 MHz with a −10 dB return loss or less within the band. In some cases, the first frequency band may be separated from the second frequency band by less than 100 MHz.

FIG. 2 is a schematic diagram showing an illustrative trap 28. The trap 28 may act as a band stop (e.g. notch) filter that has the effect of blocking first frequency electrical current in the second leg 12b of the first antenna element 12 from flowing to the third antenna element 24. The trap is operatively coupled across the gap between the second leg 12b of the first antenna element 12 at the third antenna element 24 (see FIG. 1). In the example shown, the trap 28 includes a capacitor 30 that is connected in parallel with an inductor 32. In some cases, a single inductor 32a may be used. In some cases, depending on the desired total inductance, a second inductor 32b may also be used in combination with the inductor 32a. In an example, the capacitor 30 may have a capacitance of 9.1±0.05 pF, the inductor 32a and the inductor 32b may each have an inductance of 6.8 nH±2 percent (for a total of 3.4 nH when connected in parallel as shown). This is just an example. In some cases, the inductor 32 and the capacitor 30 may be surface mount components that are positioned across the gap and soldered direct to the second leg 12b of the first antenna element 12 and the third antenna element 24.

By moving the third antenna element 24 and the trap 28 away from the distal end 18 of the second leg 12b, where the electromagnetic field of the antenna is largest, the overall sensitivity to the trap 28 is reduced. This allows the manufacturing tolerances of the capacitor and inductor values of the components 30,32 of the trap 28 to have a smaller influence, while still achieving the desired frequency response for the dual band inverted-F antenna 10. For example, since the manufacturing tolerances for the capacitor and inductor component 30,32 do not necessarily scale with the magnitude of the capacitance and/or inductance values, it can be desirable to use a capacitor component 30 in the trap 28 that has a larger capacitance value so that the ±manufacturing tolerances of the capacitor component 30 have an overall smaller effect on the filter characteristics of the trap 28. Use of a larger capacitance value is possible because the overall sensitivity of the trap 28 is reduced when moving the third antenna element 24 and the trap 28 away from the distal end 18 of the second leg 12b. Likewise, in some cases, multiple larger inductor components 32a and 32b may be provided in a parallel configuration (as shown in FIG. 2) to achieve a desired inductance value so that the ±manufacturing tolerances of the inductor components 32a 32b have an overall smaller effect on the filter characteristics of the trap 28. This may help reduce changes in the first and second frequency bands due to manufacturing tolerances of the trap components, which can be important particular where the frequency bands are relatively close to each other, such as within less than 100 MHz of each other.

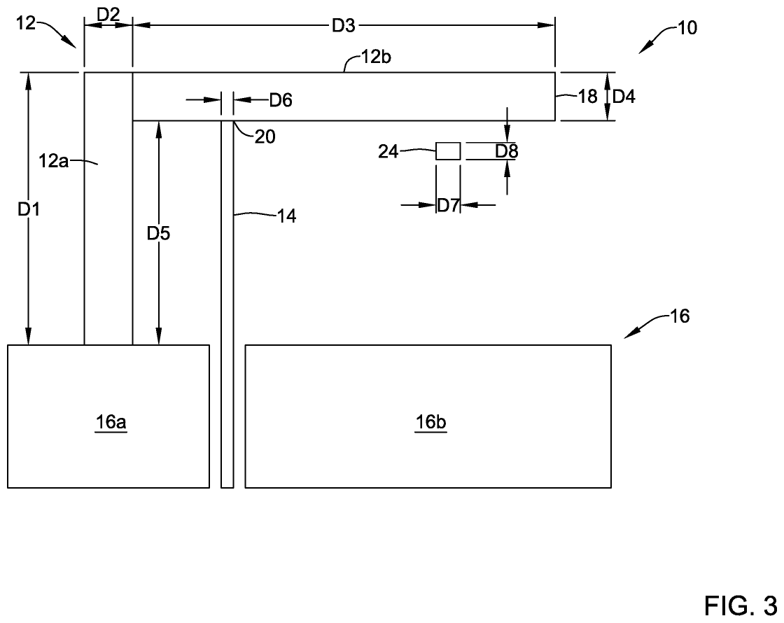

FIG. 3 is a schematic diagram of the dual band inverted-F antenna 10, showing various dimensions of the dual band inverted-F antenna 10. The first leg 12a may have a length D1 in a range of about 10 to 15 millimeters and a width D2 that is in a range of about 2 to 3 millimeters. The second leg 12b has a length D3 in a range of about 50 to 60 millimeters and a width D4 that is in a range of about 2 to 3 millimeters. The second antenna element 14 has a length D5 (between the second leg 12b and the ground plane 16) that is in a range of about 8 to 12 millimeters and a width D6 that is in a range of about 0.5 to 1 millimeter. The conductive pad of the third antenna element 24 has a length D7 that is in a range of about 3 to 4 millimeters and a width D8 that is in a range of about 1 to 2 millimeters.

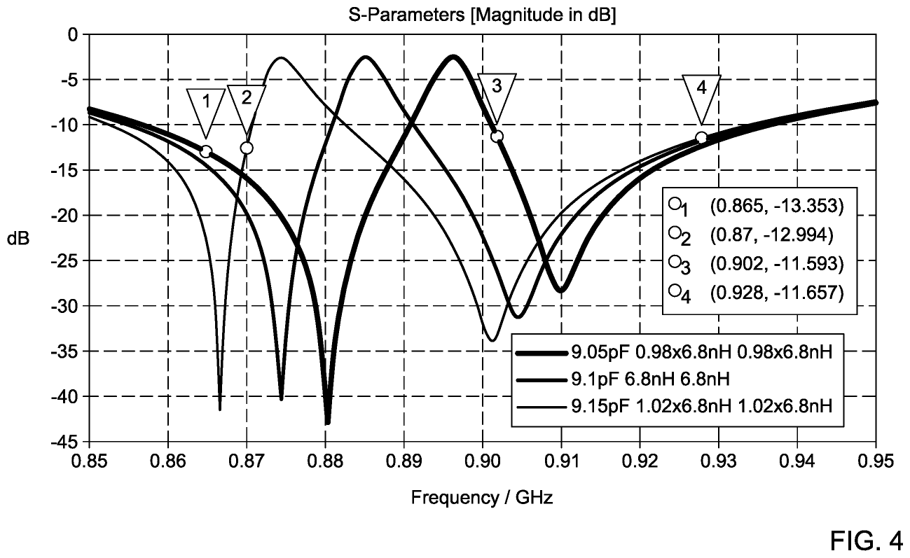

FIG. 4 is a graphical representation of a simulated frequency response for the inverted-F antenna of FIGS. 1-3. More particularly, FIG. 4 shows a plot of magnitude in decibels (dB) versus frequency in gigaherz (GHz) for a dual band inverted-F antenna such as the dual band inverted-F antenna 10. The simulated antenna had a ground plane that was 100 millimeters by 100 millimeters PEC, with a thickness of 1.6 millimeters. The antenna area was 13.5 millimeters wide. Antenna dimensions were 59.4 millimeters by 11 millimeters, antenna trace (D2 and D4) was 2.6 millimeters wide and the feed width (D6) was 0.65 millimeters. Antenna PEC thickness was 0.035 millimeters. FIG. 4 shows antenna return loss with the trap 28 including a 9.1 pF capacitor (nominal) and a pair of inductors each having an inductance of 6.8 nH (nominal). FIG. 4 also shows return loss versus frequency for the two ends of tolerance, including a 9.05 pF capacitor and a pair of 6.664 nH inductors (98% of 6.8 nH), and a 9.15 pF capacitor and a pair of 6.936 nH inductors. As can be seen, across all tolerances of the capacitor and the inductors of the trap 28, a design goal of having a return less of less than −10 dB in both the first frequency band of 865-870 MHz (noted between arrows “1” and “2” in FIG. 4) and the second frequency band of 902-928 MHz (noted between arrows “3” and “4” in FIG. 4).

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments.

What is claimed is:

1. A dual band inverted-F antenna, comprising:
a ground plane formed by a first conductive layer of a Printed Circuit Board (PCB);
a first antenna element formed by the first conductive layer, the first antenna element having a first leg and a second leg, wherein the first leg is connected to the ground plane, and the second leg extends along a length from the first leg to a distal end of the second leg parallel to the ground plane;
a second antenna element formed by the first conductive layer, the second antenna element connected to the second leg of the first antenna element at a first connection point along the length of the second leg that is proximal of the distal end of the second leg, the second antenna element electrically coupled to an antenna signal trace of the PCB;
a third antenna element formed by the first conductive layer, the third antenna element is spaced from the second leg of the first antenna element by a gap and positioned along the length of the second leg proximal of the distal end of the second leg but distal of the first connection point; and
a trap operatively coupled across the gap between the second leg of the first antenna element and the third antenna element.

2. The dual band inverted-F antenna of claim 1, wherein the trap comprises:
an inductor coupled between the second leg of the first antenna element and the third antenna element; and
a capacitor coupled between the second leg of the first antenna element and the third antenna element in parallel with the inductor.

3. The dual band inverted-F antenna of claim 1, wherein the third antenna element is proximal of the distal end of the second leg by a distance of at least 10 percent of the length of the second leg.

4. The dual band inverted-F antenna of claim 3, wherein the first connection point is proximal of the distal end of the second leg by a distance of at least 50 percent of the length of the second leg.

5. The dual band inverted-F antenna of claim 1, wherein the antenna signal trace of the PCB is operatively coupled to a dual band radio that is mounted to the PCB.

6. The dual band inverted-F antenna of claim 1, wherein the antenna signal trace of the PCB is operatively coupled to filter circuitry mounted to the PCB.

7. The dual band inverted-F antenna of claim 1, wherein the antenna signal trace of the PCB is operatively coupled to amplifier circuitry mounted to the PCB.

8. The dual band inverted-F antenna of claim 1, wherein the dual band inverted-F antenna is sensitive in a first frequency band and a second frequency band, wherein the first frequency band is non-overlapping with the second frequency band.

9. The dual band inverted-F antenna of claim 8, wherein the first frequency band includes 865-870 MHz and the second frequency band includes 902-928 MHz.

10. The dual band inverted-F antenna of claim 9, wherein the first frequency band has a bandwidth of at least 5 MHz with a −10 dB return loss or less within the band, and the second frequency band has a bandwidth of at least 20 MHz with a −10 dB return loss or less within the band.

11. The dual band inverted-F antenna of claim 8, wherein the first frequency band is separated from the second frequency band by less than 100 MHz.

12. A dual band inverted-F antenna comprising:
a planar inverted-F antenna with a trap configured to have a first frequency band and a second frequency band; and
the first frequency band is separated from the second frequency band by less than 100 MHz.

13. The dual band inverted-F antenna of claim 12, wherein the first frequency band includes 865-870 MHz and the second frequency band includes 902-928 MHz.

14. The dual band inverted-F antenna of claim 12, wherein the planar inverted-F antenna comprises:
a first antenna element;
a second antenna element connected to the first antenna element at a first connection point along the length of the first antenna element that is proximal of a distal end of the first antenna element, the second antenna element is electrically coupled to an antenna signal trace;
a third antenna element spaced from the first antenna element by a gap, the third antenna element positioned along the length of the first antenna element proximal of the distal end of the first antenna element but distal of the first connection point; and
a trap operatively coupled across the gap between the first antenna element and the third antenna element, wherein the trap includes at least one capacitor and at least one inductor.

15. The dual band inverted-F antenna of claim 14, wherein the trap is proximal of the distal end of the first antenna element.

16. The dual band inverted-F antenna of claim 15, wherein the trap is positioned proximal of the distal end of the first antenna element by a distance of at least 10 percent of a distance between the distal end of the first antenna element and the first connection point.

17. A dual band inverted-F antenna comprising:
a planar inverted-F antenna with a trap configured to have a first frequency band and a second frequency band; and
the first frequency band includes 865-870 MHz and the second frequency band includes 905-925 MHz.

18. The dual band inverted-F antenna of claim 17, wherein the planar inverted-F antenna comprises:
a first antenna element;
a second antenna element connected to the first antenna element at a first connection point along the length of the first antenna element that is proximal of a distal end of the first antenna element, the second antenna element is electrically coupled to an antenna signal trace;
a third antenna element spaced from the first antenna element by a gap, the third antenna element positioned along the length of the first antenna element proximal of the distal end of the first antenna element but distal of the first connection point; and
a trap operatively coupled across the gap between the first antenna element and the third antenna element, wherein the trap includes at least one capacitor and at least one inductor.

19. The dual band inverted-F antenna of claim 18, wherein the trap is proximal of the distal end of the first antenna element.

20. The dual band inverted-F antenna of claim 19, wherein the trap is positioned proximal of the distal end of the first antenna element by a distance of at least 10 percent of a distance between the distal end of the first antenna element and the first connection point.
